(19) United States
(12) Patent Application Publication
(10) Pub. No.: US 2023/0023431 A1
(43) Pub. Date: Jan. 26, 2023

(54) ADJUSTING RESOLUTION OF VIDEO STREAM BASED ON OPTICAL CHARACTER RECOGNITION

(71) Applicant: Lenovo (Singapore) Pte. Ltd., Singapore (SG)

(72) Inventors: Tobias Christensen, San Francisco, CA (US); Matthew Fardig, Boonville, IN (US)

(21) Appl. No.: 17/385,865

(22) Filed: Jul. 26, 2021

(51) Int. Cl. H04L 29/06; G06K 9/00; G06K 9/62

(52) U.S. Cl. CPC H04L 65/604; G06K 9/00711; G06K 9/6202; G06K 2209/01

(57) ABSTRACT

In one aspect, a first device includes at least one processor and storage accessible to the at least one processor. The storage includes instructions executable by the at least one processor to locally generate first optical character recognition (OCR) data related to at least a first video frame of content. The instructions are also executable to receive, from a second device different from the first device, second OCR data related to at least a second video frame of content. The instructions are then executable to compare the first OCR data to the second OCR data and, responsive to the comparison indicating the first OCR data does not match the second OCR data to within a threshold, take at least one action to adjust the resolution of a video stream such as a video conference's video stream.

### FIELD

The disclosure below relates to technically inventive, non-routine solutions that are necessarily rooted in computer technology and that produce concrete technical improvements. In particular, the disclosure below relates to techniques for adjusting resolution of a video stream based on optical character recognition.

### BACKGROUND

As recognized herein, online video conferences often experience bandwidth issues and broadcasting devices might also transmit conference data in formats that are not optimal for viewing at receiving devices. Furthermore, and as also recognized herein, network problems affecting data transmission might occur anywhere between the various devices of the conference, but it is often difficult if not impossible to tell at which part of the network paths the problem is occurring.

As such, the present disclosure recognizes that there might be times when text being shared by one participant is illegible at another participant's device. Furthermore, it might be difficult or impossible to determine what corrective action to take given the problem could be occurring along any of the paths. There are currently no adequate solutions to the foregoing computer-related, technological problems.

### SUMMARY

Accordingly, in one aspect a first device includes at least one processor and storage accessible to the at least one processor. The storage includes instructions executable by the at least one processor to locally generate first optical character recognition (OCR) data related to at least a first video frame of content. The instructions are also executable to receive, from a second device different from the first device, second OCR data related to at least a second video frame of content. The instructions are then executable to compare the first OCR data to the second OCR data and, responsive to the comparison indicating the first OCR data does not match the second OCR data to within a threshold, take at least one action to adjust the resolution of video for a video conference.

In some examples, the first and second OCR data may be related to text that is being provided to one or more participants as part of the video conference. Thus, e.g., the first video frame and the second video frame may both relate to a same video frame and/or a same piece of text.

Additionally, in some example implementations the first OCR data may include a first level of confidence in a first OCR result related to the first video frame, the second OCR data may include a second level of confidence in a second OCR result related to the second video frame, and the comparison may include determining whether the first and second levels of confidence match to within the threshold. Additionally, or alternatively, the first OCR data may include a first set of characters from a first OCR result related to the first video frame, the second OCR data may include a second set of characters from a second OCR result related to the second video frame, and the comparison may include determining whether the first and second sets of characters match to within the threshold.

Also in various example implementations, the first device may include a server that receives the first video frame from a client device, and the second device may include the client device, with the client device providing the second video frame to one or more participants of the video conference. In other example implementations, the first device may include a client device receiving the first video frame as part of the video conference, and the second device may include a server providing the first video frame to the client device as part of the video conference.

Additionally, if desired the second OCR data may be received from the second device over a first line of communication that is different from a second line of communication being used to transmit audio video data of the video conference. Also, if desired, the first and second OCR data may both be generated using a designated OCR algorithm common to both the first and second devices. Even further, in some examples the process of comparing respective locally-generated OCR data to respective OCR data received from another device is performed for every Nth segment of video of the video conference, where N may be an integer greater than one and where each segment may include at least one video frame.

In various examples, the at least one action itself may include refreshing a network connection, requesting a higher resolution stream for video of the video conference, requesting a higher bit rate stream for video of the video conference, requesting a reduced frame rate for video of the video conference, requesting from a server a different transcoding for video of the video conference, requesting from a client device a multicast for video of the video conference, and/or requesting a different stream of an existing multicast for video of the video conference.

Also, note that in some examples the first device may include a display accessible to the at least one processor, and the display may present the first video frame as part of the video conference.

In another aspect, a method includes locally generating, at a first device, first optical character recognition (OCR) data related to at least a first video frame of content. The method also includes receiving, from a second device different from the first device, second OCR data related to at least a second video frame of content. The method then includes analyzing the first OCR data and the second OCR data and, responsive to the analysis indicating the first OCR data does not match the second OCR data to within a threshold, taking at least one action to improve video conferencing.

Thus, in some examples taking at least one action to improve the video conferencing may include taking at least one action to adjust the resolution of video for the video conferencing. Also in some examples, the first OCR data may include a first level of confidence in a first OCR result related to the first video frame, the second OCR data may include a second level of confidence in a second OCR result related to the second video frame, and the analysis may involve determining whether the first and second levels of confidence match to within the threshold. Still further, in certain example implementations the first video frame and the second video frame may both relate to a same piece of text being provided as part of the video conferencing.

Additionally, in certain example implementations the second OCR data may be received from the second device in a first channel that is different from a second channel being used to transmit audio video data for the video conferencing. Also in certain example implementations, the process of analyzing respective locally-generated OCR data and respective OCR data received from another device may be performed for every Nth frame of video of the video conference, where N may be an integer greater than one.

In still another aspect, at least one computer readable storage medium (CRSM) that is not a transitory signal includes instructions executable by at least one processor to locally generate, at a first device, first optical character recognition (OCR) data related to at least a first frame of content. The instructions are also executable to receive, from a second device different from the first device, second OCR data related to at least a second frame of content. The instructions are further executable to compare the first OCR data to the second OCR data and, responsive to the comparison indicating the first OCR data does not match the second OCR data to within a threshold, take at least one action to adjust the resolution of a video stream.

The video stream might, for example, form part of a video conference.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 illustrates a graphical user interface (GUI) that may be presented on a broadcaster's client device during a video broadcast consistent with present principles;

FIGS. 4 and 5 illustrate GUIs that may be presented on a receiver's client device during a video broadcast consistent with present principles;

FIG. 6 shows a schematic diagram of an example process that may be used consistent with present principles;

FIG. 7 shows example logic in example flow chart format that may be executed by a device consistent with present principles; and

FIG. 8 shows an example settings GUI that may be presented on a display to configure one or more settings of a device to operate consistent with present principles.

### DETAILED DESCRIPTION

Among other things, the detailed description below relates to using OCR technology to do comparisons at key or various points in a video broadcast in order to determine where a quality correction/upgrade might result in a better-quality broadcast for the reading of text, e.g., while screen sharing. Otherwise, high resolution monitors and/or small text might wash out the text and make it difficult to read on the viewer's end. Other issues might also be at play, such as a low quality network connection between the broadcaster and the conferencing service, incorrect quality requests on the broadcast side (e.g., requesting a low quality stream from the screen itself), low quality network connection between the conferencing service and the viewer, etc. and as such, it might otherwise be difficult to determine what leg is experiencing the trouble and therefore difficult to determine what sort of auto/manual correction might help (absent the principles set forth below).

Accordingly, as described herein, OCR may be used periodically and locally on the broadcaster's client machine in order to map out the text in various areas of the screen. This text mapping output from OCR may then be sent to the server through another means such as using a separate data channel (e.g., web socket, etc.).

Likewise, on the conferencing server, OCR may be used to map text from the received broadcast. This broadcast may have traveled over the network to reach the server and therefore might have experienced some sort of loss, quality restriction, etc. The server may thus compare the OCR text that it generated from the received broadcast with the OCR text map received via the data channel itself and create a score to determine how close they match. If the quality of the OCR text on the server is less than the quality of the OCR text generated by the broadcasting client, then the application/system can assume that some sort of quality degradation has occurred between the broadcaster and the server.

The foregoing process may also be employed to allow the server to send the OCR text map it generated to the viewers of that broadcast over a data channel. Thus, the viewers' client devices may run OCR against the received broadcast and compare their OCR text map to the one received via the data channel from the server. If the quality of the client's OCR output (the viewer) is lower than the quality of the OCR data sent by the server, the application/system can assume that some sort of quality degradation has occurred between the server and the viewer.

Additionally, in some examples present principles may apply to situations in which a conferencing server might send video to a streaming service or other additional server to then be distributed to viewing clients. Similar comparisons using OCR as set forth above can be utilized between the two servers to compare quality between the conference server and the streaming service server to determine if some sort of quality degradation has occurred there on that leg as well.

Once a leg of the broadcast that is experiencing trouble is identified, remedial action may be taken by one or more of the devices automatically or manually to attempt to make the broadcast easier to read. This can include renegotiating network paths for the video along the bad leg, adjusting settings on the broadcaster to request a higher quality stream from the local screen, adjusting settings on the viewing machine to request a high-quality broadcast from the conferencing server, etc.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

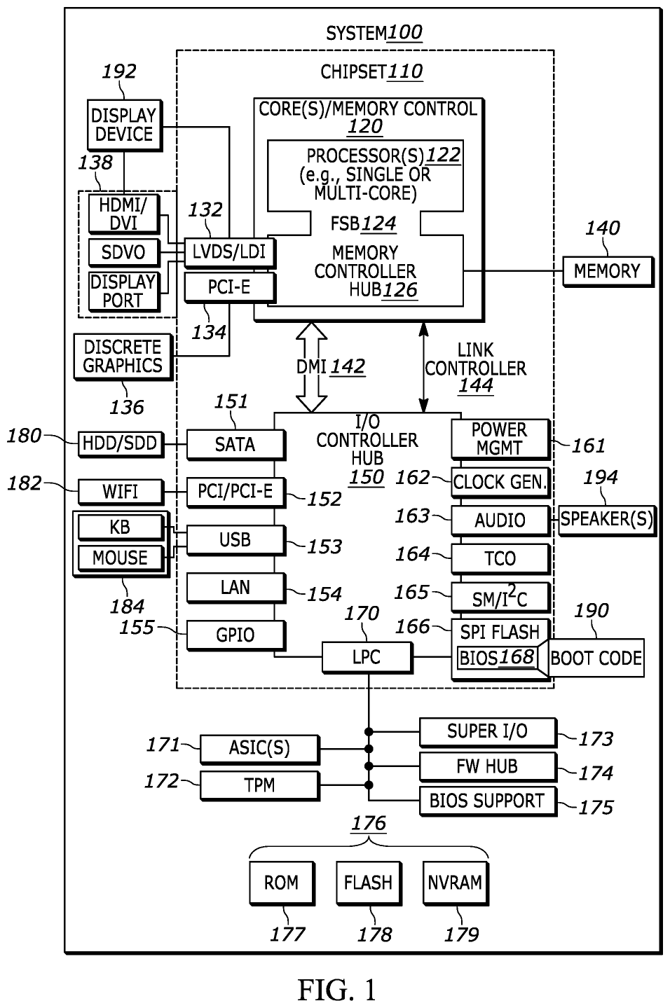

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122.

Still further, the system 100 may include an audio receiver/microphone that provides input from the microphone to the processor 122 based on audio that is detected, such as via a user providing audible input to the microphone as part of a video conference consistent with present principles. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video (e.g., as part of a video conference consistent with present principles).

Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

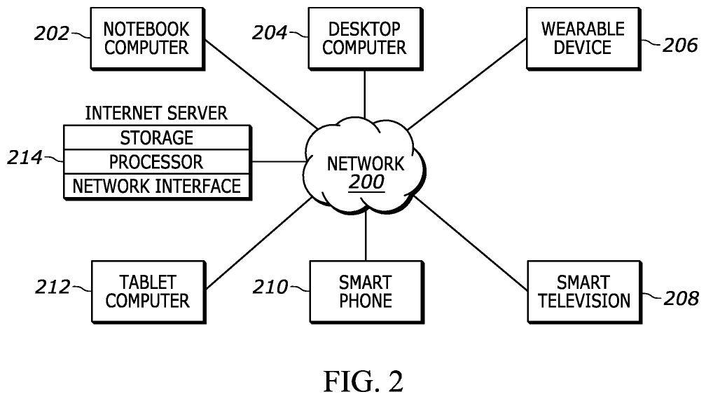

Turning now to FIG. 2, example devices are shown communicating over a network 200 such as the Internet in accordance with present principles for audio video transmission and OCR data transmission. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

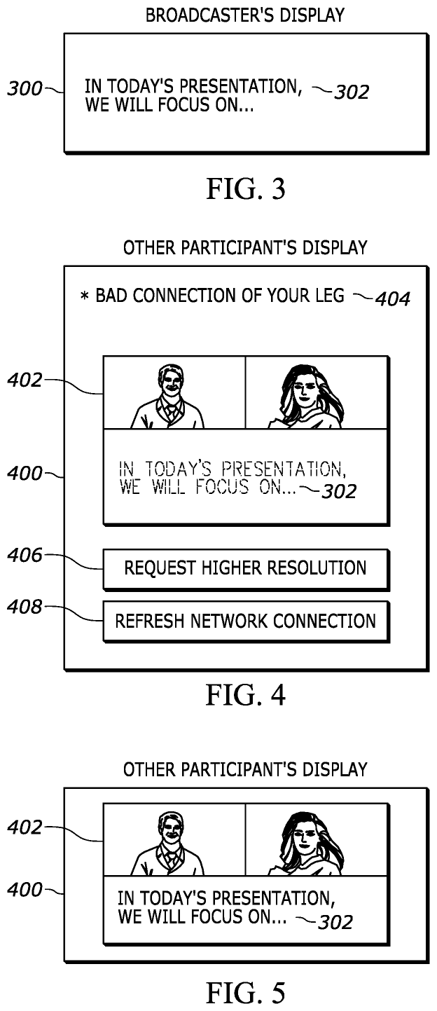

Now in reference to FIG. 3, it shows an example graphical user interface (GUI) 300 that may be presented on the display of a first participant's client device as part of a video conference video stream to others or other type of video stream to others. For example, if the video stream does not pertain to a video conference per se, it might be a broadcast stream of two people interacting with each other in person, a broadcast stream of gameplay of a video game, a broadcast stream of a webinar, a broadcast stream of other video provided through an online video hosting service, etc. But note that per the example shown in FIG. 3, the video stream is for a video conference and the first participant is labeled as a “broadcaster” as that person is understood to be broadcasting, to other conference participants and/or viewers of the video stream, audio data of the first participant speaking based on audio captured by a local microphone on the first participant's device.

Also note that the broadcaster per this example is broadcasting video/image data showing the first participant based on images of the first participant captured by a local camera on the first participant's device. However, in addition to or in lieu of broadcasting video of the first participant's face as part of the video conference, text 302 from a slide presentation, word processing document, or other digital file being shared with and/or streamed as video to other participants may also be presented on the broadcaster's local display during one or more segments of the video conference. In the present example shown in FIG. 3, the digital file is being shared as presented full-screen on the broadcaster's display and so no video images of the broadcaster or others are concurrently presented.

FIG. 4 shows that a second participant of the video conference that is remotely-located from the broadcaster may view the broadcaster's video broadcast via a GUI 400 in real time as the broadcast is received from the broadcaster's device, possibly after the broadcast is routed through a server operated by the conference service's provider and/or other devices that might be managed by a third-party content hosting platform. As shown in FIG. 4, the GUI 400 may include a section 402 indicating video streams of other participants of the video conference, one of which might be a video stream showing the broadcaster's face.

As also shown in FIG. 4, the text 302 is also presented as part of the stream shown on the GUI 400. However, owing to any number of rendering, bandwidth, network, transmission, or other issues, the text 302 as shown on the GUI 400 is pixelated and/or otherwise difficult for the local viewer (the second participant) to discern. Consistent with present principles and based on detection of this, the second participant's client device may also present a notification 404 as part of the GUI 400, with the notification 404 including text and a star icon as shown that indicate that a bad network connection has been detected on a communication leg between the second participant's client device and the conferencing server that is being used to route the video content (including the section 402 and text 302) from the broadcaster's device to the second participant's client device.

In some example implementations, the second participant's device may autonomously seek to correct the one or more issues leading to the degraded text 302, as discussed further below. However, in the present example the GUI 400 may also present selectors 406, 408 for the second participant himself or herself to provide a command for their device to take corrective action.

The selector 406 may be selectable to submit a request to one or both of the broadcaster's client device and the server in the middle to request a higher-resolution video stream to more-clearly present the text 302 at the second participant's device. This might be an appropriate action if, for example, a relatively low-resolution stream was being provided by the broadcaster's client device, but the second participant's device was using a relatively high-resolution display (e.g., 4k display), leading to a pixelated look for the text 406.

The selector 408 may be selectable to command the second participant's device to refresh one or more network connections. For example, the selector 408 may be selectable to command the second participant's device to refresh its connection to the video conferencing server/service itself, and possibly to also close and re-launch any associated conferencing application being executed locally at the second participant's client device to participate in the video conference. Additionally, or alternatively, the selector 408 may be selectable to command the second participant's device to disconnect and reconnect to a local area network (LAN) being used for the streaming, such as a local Wi-Fi network or local wired LAN at the second participant's end of the connection. In some examples, the selector 408 may also be selectable to command the local router, modem, and/or gateway for the LAN to restart or reset.

Before moving on to FIG. 5, further note that any of the foregoing actions invoked based on user selection of one of the selectors 406, 408 may also be autonomously taken by the second participant's client device.

In any case, as shown in FIG. 5, once the issue resulting in the illegibility/difficult viewing of the text 302 has been resolved, the second participant's device may remove the notification 404 and selectors 406, 408 from the GUI 400 and present the text 302 so that it is clearly legible to the second participant.

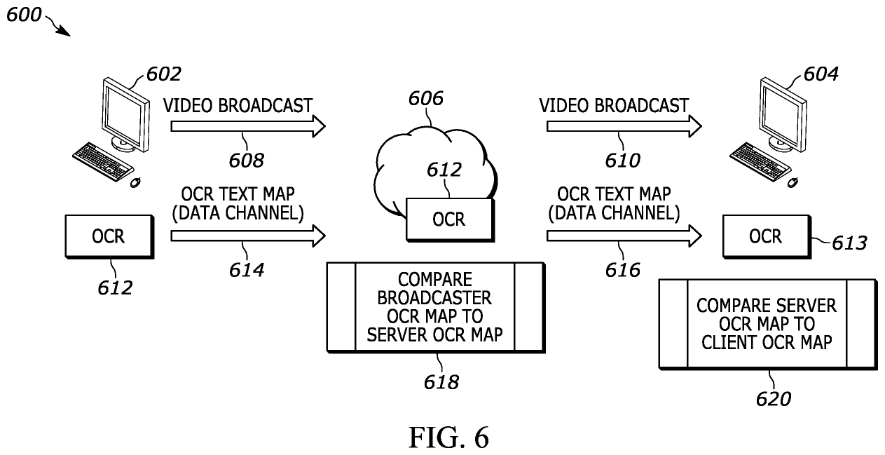

Now in reference to FIG. 6, it shows a schematic diagram 600 of an example process that may be used consistent with present principles to render text such as the text 302 legibly per FIG. 5 and other examples. The diagram 600 shows a broadcaster's client device 602 and another participant's client device 604, along with one or more servers or other devices (represented by cloud 606) through which end-to-end communications between the devices 602, 604 may be routed.

One such communication may be a video stream/broadcast from the device 602, which may be generated based on a local camera feed from the device 602 and/or based on a screen share function being executed as part of the video conference to present data at the device 604 (such as the text 302 described above). In some examples, the video broadcast may also include audio from the broadcaster as well.

The diagram 600 shows that this video broadcast may be transmitted over two different transmission legs 608, 610 on respective sides of the cloud 606. Thus, leg 608 may carry the video broadcast from the device 602 to the server/cloud 606, while leg 610 may carry the video broadcast from the server/cloud 606 to the device 604.

Note here that should a certain problem occur, such as illegibility of text being provided as part of the video broadcast, the problem might arise on either of the legs 608, 610 and it would be difficult or impossible for a viewing participant to verify precisely where the problem might be occurring. Accordingly, the devices 602, 604, and 606 may be leveraged to hone in on and address the problem. Consistent with present principles, this may be accomplished by the device 602 executing optical character recognition (OCR) in real time on the text it is presenting locally on its own display to output OCR result data 612. The data 612 may include one or more different types of OCR results, such as text characters actually identified via OCR from the local text rendering itself and also a level of confidence in the identified text. The data 612 is labeled as an OCR text map in FIG. 6 and may be transmitted to the server/cloud 606 over transmission leg 614.

Leg 616 between the server/cloud 606 and other device 604 may then be used to transmit another OCR text map 613 generated based on OCR executed locally at the server/cloud 606 on video frames received from the device 602 via the leg 608. Thus, leg 614 may carry the data 612 from the device 602 to the server/cloud 606 once the data 612 is locally generated at the device 602, while leg 616 may carry the data 613 from the server/cloud 606 to the device 604 once the data 613 is locally generated at the server 606. Use of the data 612 and 613 will be described in greater detail below.

But first, note with respect to FIG. 6 that as shown, each of the legs 614, 616 is labeled as a data channel, and the legs 614, 616 alone or in combination may form part of a separate channel/line of communication between the devices 602, 604 than the channel(s)/line(s) of communication over which the video broadcast itself is being transmitted. This may be done by using two separate and discrete communication channels on the same network and/or using different networks altogether for transmission of the data 612/613 and video broadcast. For example, a wired ethernet connection may be used to transmit the video broadcast over a LAN, and a Wi-Fi connection may be used to transmit the data 612 and/or 613. As another example, a Wi-Fi network may be used to transmit the video broadcast and a cellular Internet data network may be used to transmit the data 612 and/or 613. The data 612 and/or 613 may also be transmitted using one or more different web sockets and/or ports on the respective devices 602, 604, 606 than used for the video broadcast itself. Different hypertext transfer protocol (HTTP) transmissions for the video broadcast and data 612/613 may also be used. Additionally, or alternatively, using different channels/lines of communication may be established by using different middleman servers or other devices to route the video broadcast and data 612/613 between devices.

However, further note that in other examples the data 612/613 may be transmitted over the same channel(s)/line(s) of communication as the video broadcast itself, if desired.

As also shown in FIG. 6, for each leg 614, 616, the data 612 or 613 as received by the respective receiving device may be compared to a locally-generated OCR result determined by locally executing, at the respective receiving device, OCR on one or more image frames received from the respective transmitting device as part of the video broadcast. The same OCR algorithm that was used to generate the data 612 and/or 613 may be used by the respective receiving device to render the local result for an apples-to-apples comparison. The common OCR algorithm that is to be used may be preprogrammed at each device or the associated application it is executing, and/or may be indicated on the fly by the respective transmitting device for the respective leg.

In any case, as indicated above using the same or a similar OCR algorithm to generate both the data 612/613 and the local result at the respective receiving device may help facilitate an apples-to-apples comparison at the respective receiving device between the data 612/613 and the locally-generated OCR result in order to determine whether one or more aspects of the two results match to at least within a threshold. Actions 618, 620 as respectively executed at the server/cloud 606 or device 604 thus indicate that the respective data 612/613 generated by the respective transmitting device (device 602 for the data 612, or cloud 606 for the data 613) for a given piece of text is compared to locally-generated OCR data for the same piece of text. For example, the results comparison may relate to a same piece of text as shown in a same video frame of the video broadcast or plural video frames of the video broadcast as received from the device 602 or 606.

The results comparisons as reflected in actions 618, 620 may be based on comparisons of one or more types of OCR data from the OCR results. For example, a respective level of confidence that the transmitting device had in its own OCR result for a respective piece of text, as expressed as a percentage or another way indicated in the respective data 612/613, may be compared to a respective level of confidence that the receiving device had in its own local OCR result for the same respective piece of text. The respective levels of confidence generated by each device may be in relation to an overall level of confidence in identification of all of the text itself, or may be in relation to a level of confidence in identification of a subset of text that is less than all of the text shown in the given image frame (or frames). In either case, in these examples the threshold itself that is used for the comparisons may be a threshold of plus/minus a certain percentage level of confidence (or other metric being used). For example, the threshold level of confidence may be plus/minus five percent such that the respective levels of confidence should match to plus/minus five percent to be within the threshold.

However, in addition to or in lieu of respective levels of confidence, other aspects of the respective OCR results may also be compared via actions 618, 620. For example, a first set of characters recognized from the text by the transmitting device (either device 602 as indicated in the data 612 sent to the cloud 606, or cloud device 606 as indicated in the data 613 sent to the device 604) may be compared to a second set of characters recognized from the same corresponding portion of text by the receiving device itself (e.g., either cloud 606 or device 604). The first and second sets of characters may be recognized from all of the text for a given video frame on which OCR is executed, or may be recognized from a subset of all of the text for the given video frame. Regardless, in these examples the threshold itself that is used for the comparisons may be a threshold of plus/minus a certain number of matching characters for a given character sequence. For example, the threshold level of confidence may be plus/minus a two-character discrepancy or mismatch between the two sets of characters (each of which is supposed to pertain to the same text string from the video broadcast).

It may now be appreciated based on the foregoing description of FIG. 6 that by the cloud 606 comparing the data 612 received from the device 602 to its own locally-generated OCR result for the same respective text string, and by the device 604 comparing the data 613 received from the cloud 606 to its own locally-generated OCR result for the same respective text string, one of the legs 608, 610 for the video broadcast that is experiencing a problem leading to illegible text presentation at the device 604 may be identified so that a solution or action may be targeted to that respective leg.

For instance, if the comparison 618 results in the threshold not being met, the system may determine that the problem likely exists in the transmission of the video broadcast from the device 602 to the server/cloud 606. Likewise, if the comparison 620 results in the threshold not being met, the system may determine that the problem likely exists in the transmission of the video broadcast from the server/cloud 606 to the device 604.

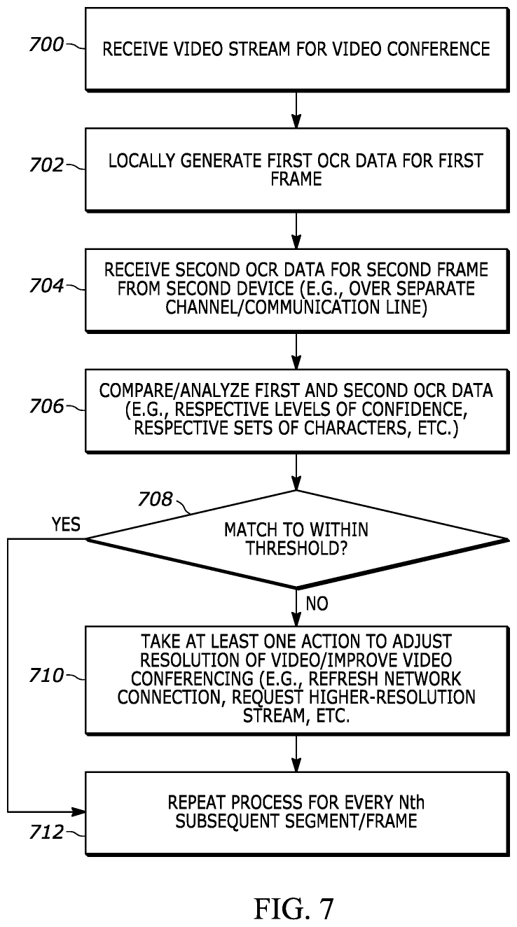

Continuing the detailed description in reference to FIG. 7, it shows example logic that may be executed by a device such as the system 100 and/or one of the devices receiving a video broadcast (e.g., the cloud 606 or device 604 of FIG. 6) consistent with present principles. Note that while the logic of FIG. 7 is shown in flow chart format, other suitable logic may also be used.

Beginning at block 700, the device may receive a video stream for a video conference or other type of video being streamed from a broadcasting device. The logic may then proceed to block 702 where the receiving device may locally generate first OCR data for at least a first frame of the received video stream using the receiving device's own local processor to locally execute the OCR algorithm. The logic may then proceed to block 704 where the receiving device may receive second OCR data for a second frame of the video stream, possibly over a separate line of communication as described above. The first frame and the second frame may be the same frame from the video stream itself, adjacent frames showing the same respective text of the video stream, or still other frames showing the same respective text of the video stream.

From block 704 the logic may then proceed to block 706 where the receiving device may compare/analyze the first and second OCR data as described above to, at decision diamond 708, determine whether the first and second OCR data matches to within a threshold. Again, note that respective levels of confidence, and/or text outputs of the OCR itself, may be compared and/or analyzed.

Additionally, or alternatively, at block 706 the receiving device may transmit the first and second OCR data to a different device/server for that other device/server to perform steps 706 and 708 and then report back to the receiving device. This may be done for redundancy, to reduce latency, and/or to reduce the processing constraints on the receiving device itself.

In any case, a negative determination at diamond 708 may cause the logic to proceed to block 710 where the receiving device may itself take one or more actions to adjust the resolution of video of the video stream or to otherwise improve the video stream's transmission and/or display presentation at the receiving device. For example, the receiving device may refresh the network connection between the sending and the receiving devices. The receiving device may also request a higher-resolution stream and/or a higher bit rate stream from the sending device (e.g., request 1080p native resolution instead of 720p native resolution from the broadcasting client device itself). The receiving device might also request a reduced frame rate for video of the video stream to reduce bandwidth consumption while still receiving and presenting relatively high-resolution frames at their true resolution to show the text without the frames being degraded in transit.

Also at block 710, and where the receiving device is a client device receiving a video broadcast and the sending device is a server relaying the video broadcast from a broadcasting client device, the receiving device may request from the server a different transcoding of the video for the video conference that has a higher resolution and/or bit rate, and/or request from the server a different stream of an existing multicast of the video (where for example a multicast at different resolutions is being streamed by the broadcasting client device to the server itself and then the server selects and provides a single stream from the multicast to the receiving device).

At block 710, the receiving client device may also request that the broadcasting client device begin a multicast for the video so that the relaying server can ultimately select and stream a higher-resolution stream to the receiving client device without the server itself being burdened with extra processing to provide a different transcoding on the fly. Instead, in this case the server could simply relay a different, higher-resolution video stream as already generated by the broadcasting client device itself.

From block 710 the logic may proceed to block 712. Or in examples where an affirmative determination is made at diamond 708 rather than a negative one, the logic may skip block 710 and instead move directly to block 712. In either case, at block 712 the receiving device may repeat the process of FIG. 7 for every Nth segment of video of the video conference, where “N” may be an integer greater than one. Each Nth segment may include at least one video frame so that, for example, every fifth frame is analyzed according to steps 702 through 708 and remedial action potentially taken at block 710. Additionally, or alternatively, each Nth segment may be defined by time such that, for example, a frame received every two seconds is analyzed according to steps 702 through 708 and a remedial action potentially taken at block 710. In either case, this may help reduce the processing burden of performing the steps of FIG. 7 by doing those steps for every Nth frame/segment rather than for every frame, for example.

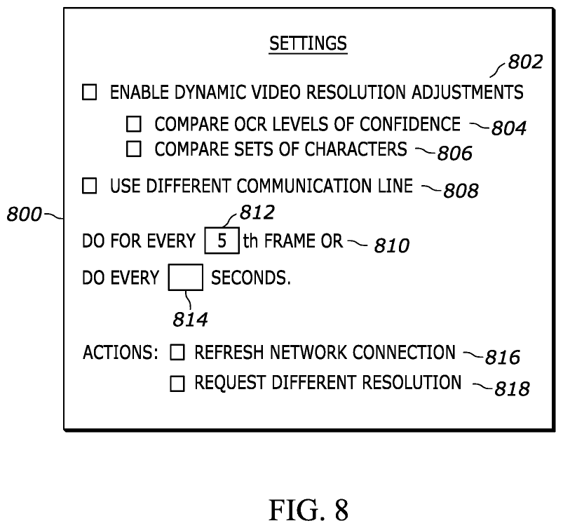

Now describing FIG. 8, it shows an example GUI 800 that may be presented on a display of a receiving device that operates consistent with present principles to configure one or more settings of the device to operate as described herein. For example, the GUI 800 may be presented at a server display or receiving client device display. In the present example, each option or sub-option that will be discussed below may be selected by directing touch or cursor input to the respectively adjacent check box.

As shown, the GUI 800 may include a first option 802 that may be selectable to set or enable the receiving device to, in the future, undertake present principles. For example, the option 802 may be selected a single time to set or configure the receiving device to subsequently undertake the logic of FIG. 7 and execute other receiving device functions described above for one or plural different video streams/conferences conducted at different future times. Beneath the option 802 may be sub-options 804, 806. Sub-option 804 may be selected to set the receiving device to compare respective levels of confidence per block 706 and diamond 708 above. Sub-option 806 may be selected to set the receiving device to compare respective sets of characters per block 706 and diamond 708 above.

Additionally, if desired the GUI 800 may include an option 808. The option 808 may be selected to set or configure the receiving device to use a different line of communication for transceiving OCR data as described herein, rather than using the same line of communication over which audio video data of a video conference or other video broadcast is being received. By using a different line of communication, additional bandwidth may not be consumed on the line through which the video itself is being received, which might cause further bandwidth issues. Using the different line of communication may also help ensure that the OCR data itself gets to its destination even if there is a network problem on the other line through which the audio video data is being received.

Still further, the GUI 800 may include a setting 810 at which a user of the receiving device may define how frequently the process of FIG. 7 is executed. For example, the user may enter a number into box 812 to establish the frequency as being every Nth video frame, with N being defined here by the number entered into the box 812. Additionally, or alternatively, the user may enter a number into box 814 to establish the frequency in a time-based manner, with N being defined here by a number of seconds, minutes, etc.

Still further, the GUI 800 may include options for the user to select one or more particular remedial actions to take, e.g., at block 710 above. Only two are shown in FIG. 8 for simplicity, but any or all of the remedial actions described above may be presented as options on the GUI 800. In the present example, option 816 may be selected to select the action of refreshing a network connection, while option 818 may be selected to select the action of requesting a different resolution for video frames being received.

Moving on from FIG. 8, it is to be understood consistent with present principles that a receiving device might, before or while performing steps 702 through 708 above, preemptively request a higher resolution or faster bit rate for video upon recognizing any text for a given frame or set of frames while the device subsequently performs the steps themselves. This may help further reduce latency in effecting a remedy for a text viewing issue as described herein. But conversely, if no text is identified at this stage, then the receiving device might request a lower bit rate or frame resolution to reduce and thus improve bandwidth consumption.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A first device, comprising:
at least one processor; and
storage accessible to the at least one processor and comprising instructions executable by the at least one processor to:
locally generate first optical character recognition (OCR) data related to at least a first video frame of content;
receive, from a second device different from the first device, second OCR data related to at least a second video frame of content;
compare the first OCR data to the second OCR data; and
responsive to the comparison indicating the first OCR data does not match the second OCR data to within a threshold, take at least one action to adjust the resolution of video for a video conference.

2. The first device of claim 1, wherein the first and second OCR data are related to text that is being provided to one or more participants as part of the video conference.

3. The first device of claim 1, wherein the first OCR data comprises a first level of confidence in a first OCR result related to the first video frame, wherein the second OCR data comprises a second level of confidence in a second OCR result related to the second video frame, and wherein the comparison comprises determining whether the first and second levels of confidence match to within the threshold.

4. The first device of claim 1, wherein the first OCR data comprises a first set of characters from a first OCR result related to the first video frame, wherein the second OCR data comprises a second set of characters from a second OCR result related to the second video frame, and wherein the comparison comprises determining whether the first and second sets of characters match to within the threshold.

5. The first device of claim 1, wherein the first video frame and the second video frame both relate to a same video frame of a particular video stream.

6. The first device of claim 1, wherein the first device comprises a server that receives the first video frame from a client device, and wherein the second device comprises the client device, the client device providing the second video frame to one or more participants of the video conference.

7. The first device of claim 1, wherein the first device comprises a client device receiving the first video frame as part of the video conference, and wherein the second device comprises a server providing the first video frame to the client device as part of the video conference.

8. The first device of claim 1, wherein the second OCR data is received from the second device over a first line of communication that is different from a second line of communication being used to transmit audio video data of the video conference.

9. The first device of claim 1, wherein the first and second OCR data are both generated using a designated OCR algorithm common to both the first and second devices.

10. The first device of claim 1, wherein the process of comparing respective locally-generated OCR data to respective OCR data received from another device is performed for every Nth segment of video of the video conference, N being an integer greater than one, each segment comprising at least one video frame.

11. The first device of claim 1, wherein the at least one action comprises one or more of: refreshing a network connection, requesting a higher resolution stream for video of the video conference, requesting a higher bit rate stream for video of the video conference, requesting a reduced frame rate for video of the video conference, requesting from a server a different transcoding for video of the video conference, requesting from a client device a multicast for video of the video conference, requesting a different stream of an existing multicast for video of the video conference.

12. (canceled)

13. A method, comprising:
locally generating, at a first device, first optical character recognition (OCR) data related to at least a first video frame of content;
receiving, from a second device different from the first device, second OCR data related to at least a second video frame of content;
analyzing the first OCR data and the second OCR data; and
responsive to the analysis indicating the first OCR data does not match the second OCR data to within a threshold, taking at least one action to improve video conferencing;
wherein taking at least one action to improve the video conferencing comprises taking at least one action to adjust the resolution of video for the video conferencing.

14. (canceled)

15. The method of claim 13, wherein the first OCR data comprises a first level of confidence in a first OCR result related to the first video frame, wherein the second OCR data comprises a second level of confidence in a second OCR result related to the second video frame, and wherein the analysis involves determining whether the first and second levels of confidence match to within the threshold.

16. The method of claim 13, wherein the first video frame and the second video frame both relate to a same piece of text being provided as part of the video conferencing.

17. The method of claim 13, wherein the second OCR data is received from the second device in a first channel that is different from a second channel being used to transmit audio video data for the video conferencing.

18. The method of claim 13, wherein the process of analyzing respective locally-generated OCR data and respective OCR data received from another device is performed for every Nth frame of video of the video conference, N being an integer greater than one.

19. At least one computer readable storage medium (CRSM) that is not a transitory signal, the computer readable storage medium comprising instructions executable by at least one processor to:
locally generate, at a first device, first optical character recognition (OCR) data related to at least a first frame of content;
receive, from a second device different from the first device, second OCR data related to at least a second frame of content;
compare the first OCR data to the second OCR data; and
responsive to the comparison indicating the first OCR data does not match the second OCR data to within a threshold, take at least one action to adjust the resolution of a video stream.

20. The CRSM of claim 19, wherein the video stream forms part of a video conference.

21. The method of claim 13, wherein the at least one action comprises one or more of: refreshing a network connection, requesting a higher resolution stream for video of the video conferencing, requesting a higher bit rate stream for video of the video conferencing, requesting a reduced frame rate for video of the video conferencing, requesting from a server a different transcoding for video of the video conferencing, requesting from a client device a multicast for video of the video conferencing, requesting a different stream of an existing multicast for video of the video conferencing.

22. The CRSM of claim 19, wherein the at least one action comprises one or more of: refreshing a network connection, requesting a higher resolution stream for video of a video conference, requesting a higher bit rate stream for video of the video conference, requesting a reduced frame rate for video of the video conference, requesting from a server a different transcoding for video of the video conference, requesting from a client device a multicast for video of the video conference, requesting a different stream of an existing multicast for video of the video conference.
